(19) United States
(12) Patent Application Publication
(10) Pub. No.: US 2025/0363030 A1
(43) Pub. Date: Nov. 27, 2025

(54) MULTIPLE-VIRTUAL-TEMPERATURE-SENSOR-PER-COMPUTING-COMPONENT COOLING SYSTEM

(71) Applicant: Dell Products L.P., Round Rock, TX (US)

(72) Inventors: Chandrasekhar Mugunda, Austin, TX (US); Rui An, Austin, TX (US); Shivabasava Karibasappa Komaranalli, Round Rock, TX (US); Dheeraj Butukuri, Cedar Park, TX (US)

(21) Appl. No.: 18/672,811

(22) Filed: May 23, 2024

(51) Int. Cl. G06F 11/30; G01K 1/02; G01K 1/14; G06F 1/20

(52) U.S. Cl. CPC G06F 11/3058; G01K 1/026; G01K 1/14; G06F 1/206; G01K 2213/00

(57) ABSTRACT

A multiple-virtual-temperature-sensor-per-computing-component cooling system includes a chassis housing a cooling system and a BMC device coupled to a computing component that includes physical temperature sensors. The BMC device identifies the physical temperature sensors included in the computing component, and creates virtual device(s) that includes a respective virtual temperature sensor for each of the physical temperature sensors. The BMC device then retrieves respective temperature data from each of the physical temperature sensors and, for each virtual temperature sensor included in the virtual device(s), provides the respective temperature data that was retrieved from the physical temperature sensor for which that virtual temperature sensor was created in a cooling system control algorithm to generate cooling system control information. The BMC device then uses the cooling system control information to control the cooling system.

### BACKGROUND

The present disclosure relates generally to information handling systems, and more particularly to using multiple virtual temperature sensors to provide for the cooling of a component in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, include cooling systems for cooling the components in those computing devices. Furthermore, as computing devices are being developed to support compute-intense functionality such as Artificial Intelligence (AI) applications that utilize multi-Graphics Processing Unit (GPU) components available from NVIDIA® Corporation of Santa Clara, California, United States; AMD® Inc. of Santa Clara, California, United States; and INTEL® Corporation of Santa Clara, California, United States, the cooling of such components becomes complicated. For example, a multi-GPU component like those discussed above may include a plurality of devices that include GPUs, Field Programmable Gate Arrays (FPGAs), Peripheral Component Interconnect express (PCIe) re-timers, switches, and/or other devices known in the art that may each require cooling and may include a respective temperature sensor for use in such cooling.

Many computing devices include a Baseboard Management Controller (BMC) device to manage and monitor the components in the computing device, and such BMC devices are often responsible for the cooling of the components in the computing device. In an effort to streamline out-of-band management for the BMC device, many component vendors have adopted a single consolidated management path that utilizes the industry-standard Platform Level Data Model (PLDM) protocol for the aggregation of telemetry data, temperature data, power data, health data, and other computing component data known in the art. To provide a specific example, BMC devices like those discussed above are configured to monitor temperature data from temperature sensor(s) in computing components that utilize the PLDM protocol (“PLDM devices”), calculate Pulse Width Modulation (PWM) values for the temperature data received from each temperature sensor, and use the highest PWM value to control a cooling system in the computing device. However, the calculation of PWM values is relatively processing intensive, and in order to conserve its processing resources the BMC device is configured to only utilize temperature data from a maximum of 4 temperature sensors per PLDM device in its cooling algorithm (e.g., by only allowing 4 temperature sensors per PLDM device in a platform table of the BMC device).

Furthermore, computing components like the multi-GPU components discussed above may include 50 or more temperature sensors for their devices, and conventional solutions to such issues is to have the vendor of the multi-GPU component identify the 4 temperature sensors in the multi-GPU component that are known to report the hottest temperatures, and then only identify those 4 temperature sensors from the multi-GPU component in the platform table of the BMC device so that the BMC device only reads temperature data that is generated by those 4 temperature sensors and stored in the Platform Descriptor Record (PDR) when monitoring that multi-GPU component. Such conventional solutions are not ideal for complex computing components like the multi-GPU components described above, as they ignore the majority of temperature sensors on those computing components, require pre-defined indications of temperature sensors for monitoring and corresponding manual configuration of the monitoring of those temperature sensors as described above, and necessitate firmware modifications for the computing components.

Accordingly, it would be desirable to provide a computing component cooling system that addresses the issues discussed above.

### SUMMARY

According to one embodiment, an Information Handling System (IHS) includes a Baseboard Management Controller (BMC) processing system; and a BMC memory system that is coupled to the BMC processing system and that includes instructions that, when executed by the BMC processing system, cause the BMC processing system to provide a BMC engine that is configured to: identify a plurality of physical temperature sensors included in a computing component that is coupled to the BMC processing system; create at least one virtual device that includes a respective virtual temperature sensor for each of the plurality of physical temperature sensors; retrieve respective temperature data from each of the plurality of physical temperature sensors; provide, for each virtual temperature sensor included in the at least one virtual device, the respective temperature data that was retrieved from the physical temperature sensor for which that virtual temperature sensor was created in a cooling system control algorithm to generate cooling system control information; and use the cooling system control information to control a cooling system.

### BRIEF DESCRIPTION OF THE DRAWINGS

FIG. 1 is a schematic view illustrating an embodiment of an Information Handling System (IHS).

FIG. 2 is a schematic view illustrating an embodiment of a computing device that may include the multiple-virtual-temperature-sensor-per-computing-component cooling system of the present disclosure.

FIG. 3 is a schematic view illustrating an embodiment of a computing component that may be included in the computing device of FIG. 2.

FIG. 4 is a flow chart illustrating an embodiment of a method for controlling a cooling system using multiple virtual temperature sensors per computing component.

FIG. 5 is a schematic view illustrating an embodiment of the computing device of FIG. 2 operating during the method of FIG. 4.

FIG. 6A is a schematic view illustrating an embodiment of the computing device of FIG. 2 operating during the method of FIG. 4.

FIG. 6B is a schematic view illustrating an embodiment of the computing component of FIG. 3 operating during the method of FIG. 4.

FIG. 7 is a schematic view illustrating an embodiment of a BMC subsystem in the computing component of FIG. 3 operating during the method of FIG. 4.

FIG. 8 is a schematic view illustrating an embodiment of a BMC subsystem in the computing component of FIG. 3 operating during the method of FIG. 4.

FIG. 9 is a schematic view illustrating an embodiment of a BMC subsystem in the computing component of FIG. 3 operating during the method of FIG. 4.

FIG. 10A is a schematic view illustrating an embodiment of the computing device of FIG. 2 operating during the method of FIG. 4.

FIG. 10B is a schematic view illustrating an embodiment of the computing component of FIG. 3 operating during the method of FIG. 4.

FIG. 11 is a schematic view illustrating an embodiment of the computing device of FIG. 2 operating during the method of FIG. 4.

FIG. 12 is a schematic view illustrating an embodiment of the computing device of FIG. 2 operating during the method of FIG. 4.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

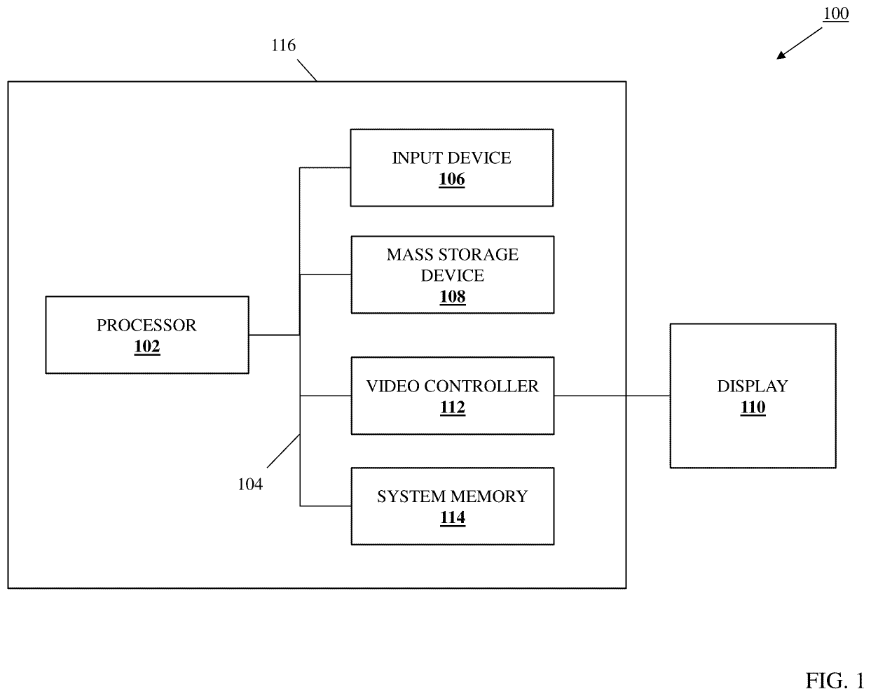

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

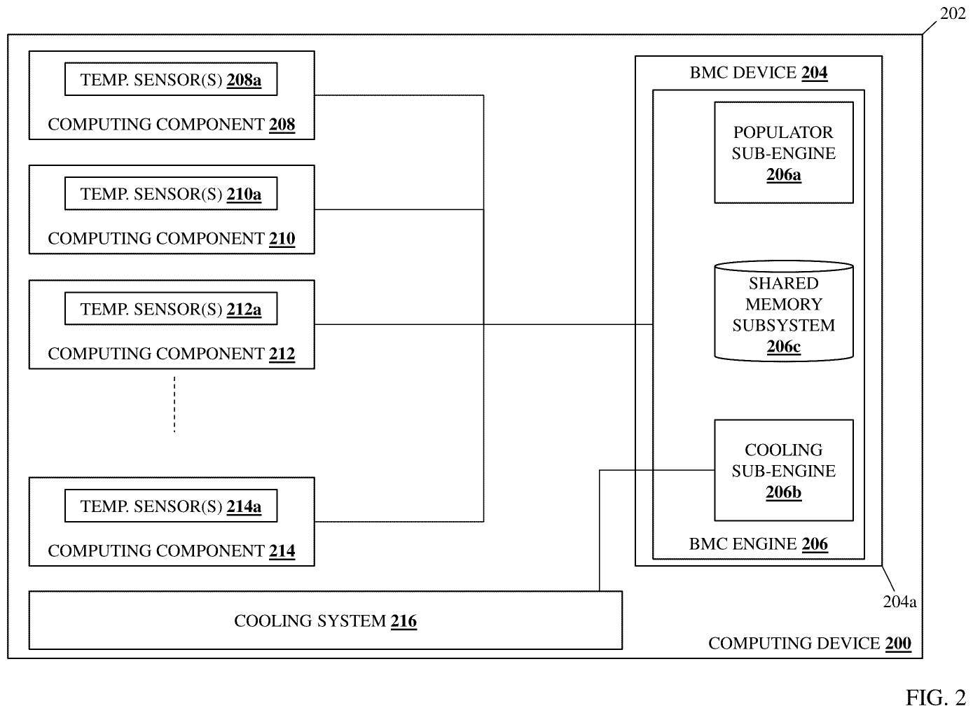

Referring now to FIG. 2, an embodiment of a computing device 200 is illustrated that may include the multiple-virtual-temperature-sensor-per-computing-component cooling system of the present disclosure. In an embodiment, the computing device 200 may be provided by the IHS 100 discussed above with reference to FIG. 1 and/or may include some or all of the components of the IHS 100, and in specific examples may be provided by a server device. However, while illustrated and discussed as being provided by a server device, one of skill in the art in possession of the present disclosure will recognize that the functionality of the computing device 300 discussed below may be provided by other computing devices that are configured to operate similarly as the computing device 200 discussed below.

In the illustrated embodiment, the computing device 200 includes a chassis 202 that houses the components of the computing device 200, only some of which are illustrated and discussed below. For example, the chassis 202 may house BMC device 204 that may be provided by the integrated DELL® Remote Access Controller (iDRAC) provided in server devices available from DELL® Inc. of Round Rock, Texas, United States, as well as any other BMC devices that would be apparent to one of skill in the art in possession of the present disclosure. As such, one of skill in the art in possession of the present disclosure will appreciate how the BMC device 204 may be configured to provide an out-of-band management platform that includes mostly separate resources from the computing device 200 that are configured to provide a browser-based interface or Command Line Interface (CLI) for managing and monitoring components in the computing device 200.

In the illustrated embodiment, the BMC device 204 includes a chassis 204a (e.g., a circuit board) that supports the components of the BMC device 204, only some of which are illustrated and described below. For example, the chassis 204a may support a BMC processing system (not illustrated, but which may be similar to the processor 102 discussed above with reference to FIG. 1) and a BMC memory system (not illustrated, but which may be similar to the memory 114 discussed above with reference to FIG. 1) that is coupled to the BMC processing system and that includes instructions that, when executed by the BMC processing system, cause the BMC processing system to provide a BMC engine 206 that is configured to perform the functionality of the BMC engines and/or BMC devices discussed below.

In the illustrated embodiment, the BMC engine 206 includes a populator sub-engine 206a. In the specific examples provided below, the populator sub-engine 206a is configured to provide a Platform Level Data Model (PLDM) populator, and thus the BMC processing system/BMC memory system discussed above may be configured to communicate via a PLDM over Management Component Transport Protocol (PLDM-over-MCTP) stack (e.g., using PLDM Type 2 and PLDM Type 5 functionality over MCTP). However, while a particular populator sub-engine is described, one of skill in the art in possession of the present disclosure will appreciate how the functionality of the populator sub-engine 206a may be provided by different populators used with other consolidated management paths/protocols (e.g., Redfish over Universal Serial Bus-Network Interface Controller (USB-NIC)) while remaining within the scope of the present disclosure as well.

In the illustrated embodiment, the BMC engine 206 also includes a cooling sub-engine 206b that, in the examples provided below, is described as including a thermal daemon and a cooling control algorithm, but one of skill in the art in possession of the present disclosure will appreciate how the cooling sub-engine 206b may be configured to perform a variety of other cooling functionality while remaining within the scope of the present disclosure as well. In the illustrated embodiment, the BMC engine 206 also includes a shared memory subsystem 206c that may be provided by the BMC memory system discussed above and that is configured to be shared between the populator sub-engine 206a and the cooling sub-engine 206b (i.e., the PLDM populator and the thermal daemon discussed above). However, while a specific BMC device 204 has been illustrated and described, one of skill in the art in possession of the present disclosure will appreciate how the BMC device of the present disclosure may include a variety of components and/or component configurations while remaining within the scope of the present disclosure as well.

The chassis 202 also houses a plurality of computing components 208, 210, 212, and up to 214 that are each coupled to the BMC engine 204 (e.g., via a coupling (e.g., an Inter-Integrated Circuit (I2C) coupling for use with PLDM communications, a USB coupling for USB-NIC communications, etc.) between each of the computing components 208-214 and the BMC processing system). Each of the computing components 208-214 is illustrated as including at least one temperature sensor 208a, 210a, 212a, and up to 214a, respectively. As will be appreciated by one of skill in the art in possession of the present disclosure, each of the temperature sensor(s) 208a, 210a, 212a, and up to 214a in the embodiments illustrated and described below are “physical” temperature sensors that are configured to determine a temperature associated with the computing component, and may be distinguished from the “virtual” temperature sensors that are created and used by the BMC device 204 as discussed in further detail below. As discussed in various specific examples provided below, any of the computing components 208-214 may include a single physical temperature sensor, up to a maximum of four physical temperature sensors, or more than four physical temperature sensors based on a 4 temperature sensor limit per computing component for the BMC engine in those specific examples. However, temperature sensor limits per computing components higher than 4 will fall within the scope of the present disclosure as well.

The chassis 202 also houses a cooling system 216 that is coupled to the cooling sub-engine 206b in the BMC engine 206, and that may include a fan system having one or more fan devices, a liquid cooling system, and/or any other cooling components or configurations that one of skill in the art in possession of the present disclosure will recognize as falling within the scope of the present disclosure. However, while a specific computing device 200 has been illustrated and described, one of skill in the art in possession of the present disclosure will recognize that computing devices (or other devices operating according to the teachings of the present disclosure in a manner similar to that described below for the computing device 200) may include a variety of components and/or component configurations for providing conventional computing device functionality, as well as the multiple-virtual-temperature-sensor-per-computing-component cooling functionality discussed below, while remaining within the scope of the present disclosure as well.

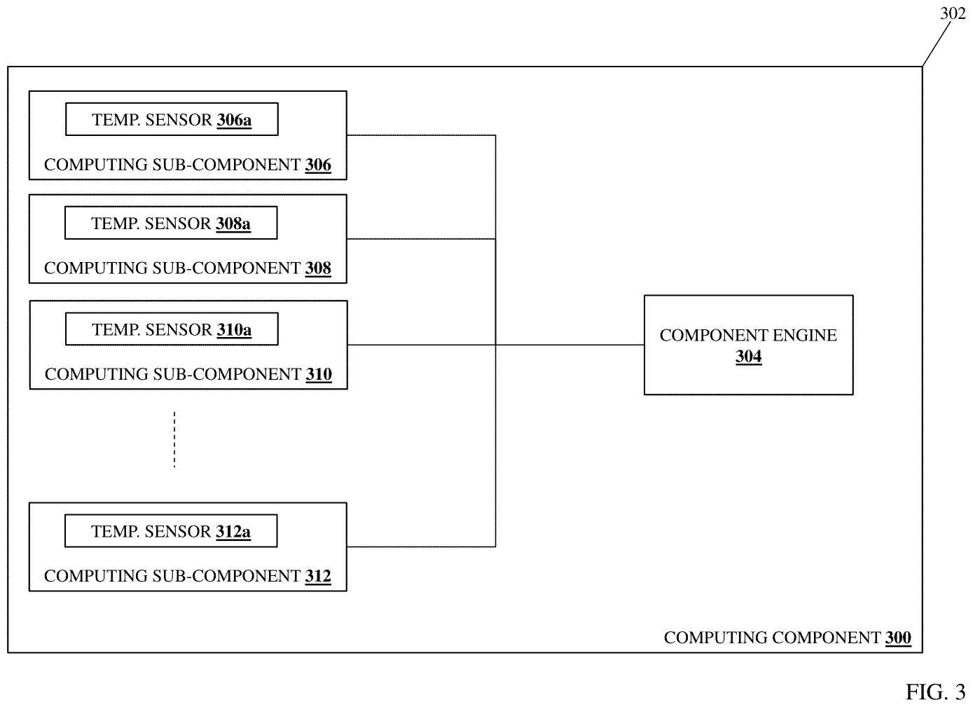

Referring now to FIG. 3, an embodiment of a computing component 300 is illustrated that may provide any of the computing components 208-214 discussed above with reference to FIG. 2. As will be appreciated by one of skill in the art in possession of the present disclosure, the computing component 300 provides an example of a computing component including a number of temperature sensors that exceeds the 4 temperature sensor limit per computing component for the BMC engine in the BMC device 204 discussed in further detail in the specific examples provided below. In the illustrated embodiment, the computing component 300 includes a chassis 302 that supports the components of the computing component 300, only some of which are illustrated and described below. For example, the chassis 302 may support a component processing system (not illustrated, but which may be included in a component controller) and a component memory system (not illustrated, but which may be included in a component controller) that is coupled to the component processing system and that includes instructions that, when executed by the component processing system, cause the component processing system to provide a component engine 304 that is configured to perform the functionality of the component engines and/or computing components discussed below.

As illustrated, the chassis 302 supports a plurality of computing sub-components 306, 308, 310, and up to 312 that are each coupled to the component engine 304 (e.g., via a coupling between each of the computing sub-components 306-312 and the component processing system). Each of the computing sub-components 306-312 is illustrated as including a respective temperature sensor 306a, 308a, 310a, and up to 312a, respectively. Similarly as described above, each of the temperature sensors 306a, 308a, 310a, and up to 312a in the embodiments illustrated and described below are “physical” temperature sensors that are configured to determine a temperature associated with the computing sub-component, and that may be distinguished from the “virtual” temperature sensors that are created and used by the BMC device 204 as discussed in further detail below.

In a specific example, the computing component 300 may be provided by a multi-GPU component like those available from NVIDIA® Corporation of Santa Clara, California, United States; AMD® Inc. of Santa Clara, California, United States; and INTEL® Corporation of Santa Clara, California, United States, discussed above. As such, the computing component 300 may include a plurality of sub-components such as GPUs (e.g., eight GPUs), Field Programmable Gate Arrays (FPGAs), Peripheral Component Interconnect express (PCIe) re-timers, switches, and/or other computing sub-components known in the art, with a respective temperature sensor (i.e., the temperature sensors 306a-312a) provided for each of those computing sub-components. However, while a specific computing component 300 has been illustrated and described, one of skill in the art in possession of the present disclosure will recognize that computing components (or other devices operating according to the teachings of the present disclosure in a manner similar to that described below for the computing components 300) may include a variety of sub-components and/or sub-component configurations for providing conventional component functionality, as well as the multiple-virtual-temperature-sensor-per-computing-component cooling functionality discussed below, while remaining within the scope of the present disclosure as well.

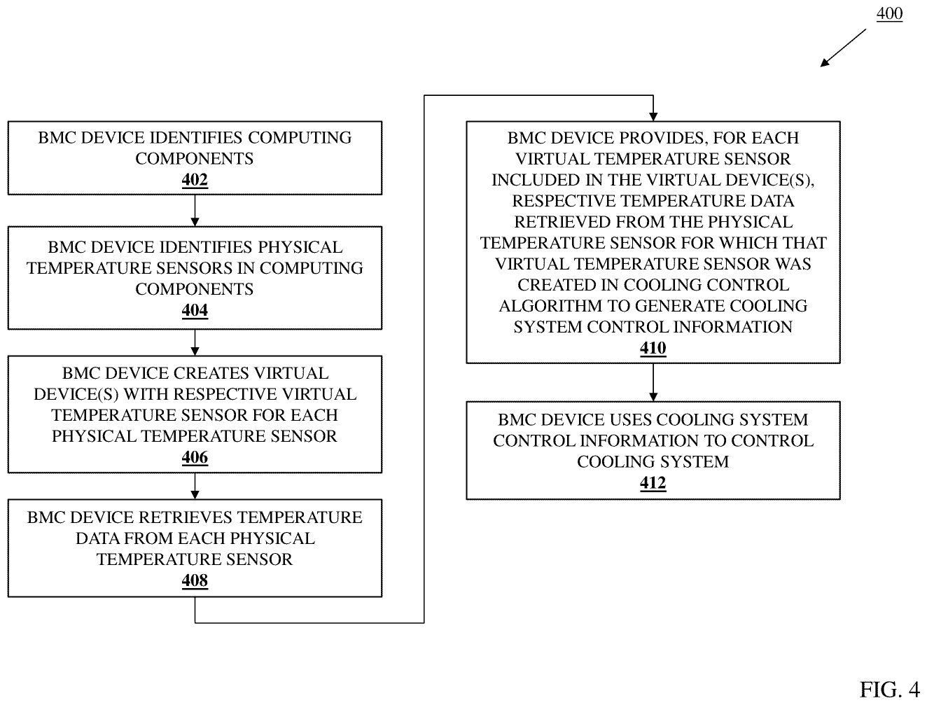

Referring now to FIG. 4, an embodiment of a method 400 for controlling a cooling system using multiple virtual temperature sensors per computing component is illustrated. As discussed below, the systems and methods of the present disclosure create one or more virtual devices having a plurality of virtual temperature sensors that each correspond to one of a plurality of physical temperature sensors in a computing component, and then provide, for each virtual temperature sensor in the virtual device(s), temperature data retrieved from its corresponding physical temperature sensor in a cooling control algorithm for use in controlling a cooling system. For example, the multiple-virtual-temperature-sensor-per-computing-component cooling system may include a chassis housing a cooling system and a BMC device coupled to a computing component that includes physical temperature sensors. The BMC device identifies the physical temperature sensors included in the computing component, and creates virtual device(s) that includes a respective virtual temperature sensor for each of the physical temperature sensors. The BMC device then retrieves respective temperature data from each of the physical temperature sensors and, for each virtual temperature sensor included in the virtual device(s), provides the respective temperature data that was retrieved from the physical temperature sensor for which that virtual temperature sensor was created in a cooling system control algorithm to generate cooling system control information. The BMC device then uses the cooling system control information to control the cooling system. As such, a temperature sensor limit per computing component for the BMC device will not prevent the monitoring of temperature sensors in a computing component that exceeds that temperature sensor limit.

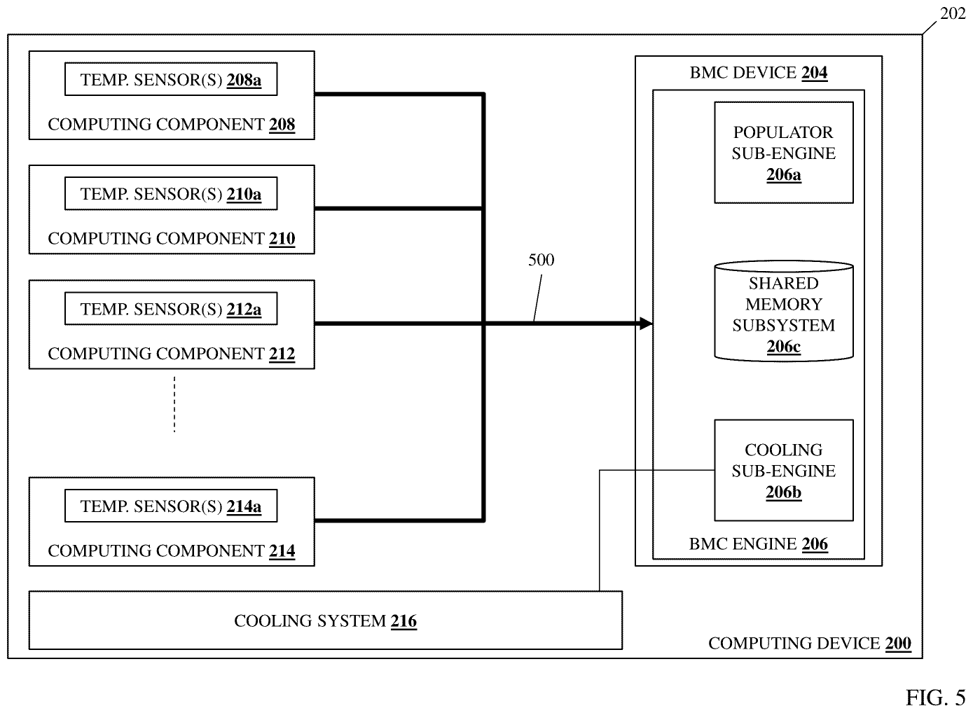

The method 400 begins at block 402 where a BMC device identifies computing components. With reference to FIG. 5, in an embodiment of block 402, the BMC engine 206 in the BMC device 204 may perform computing component identification operations 500 that may include identifying each of the computing components 208-214 (which may include the computing component 300 discussed above with reference to FIG. 3) during, for example, enumeration operations, computing component discovery operations, and/or any other computing component identification scenarios that would be apparent to one of skill in the art in possession of the present disclosure. Furthermore, while the identification of a plurality of computing components 208-214 and 300 that are included in the chassis 202 with the BMC device 204 is illustrated and described, one of skill in the art in possession of the present disclosure will appreciate how external computing components (i.e., computing components outside the chassis 202) that are coupled to the BMC device 204 may be identified at block 402 as well.

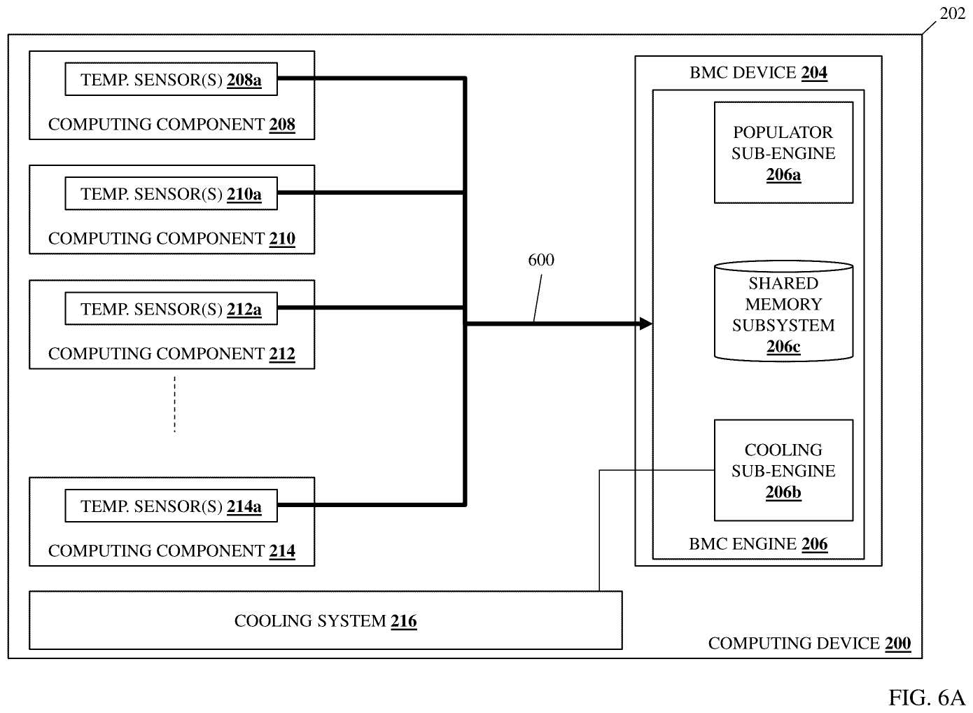

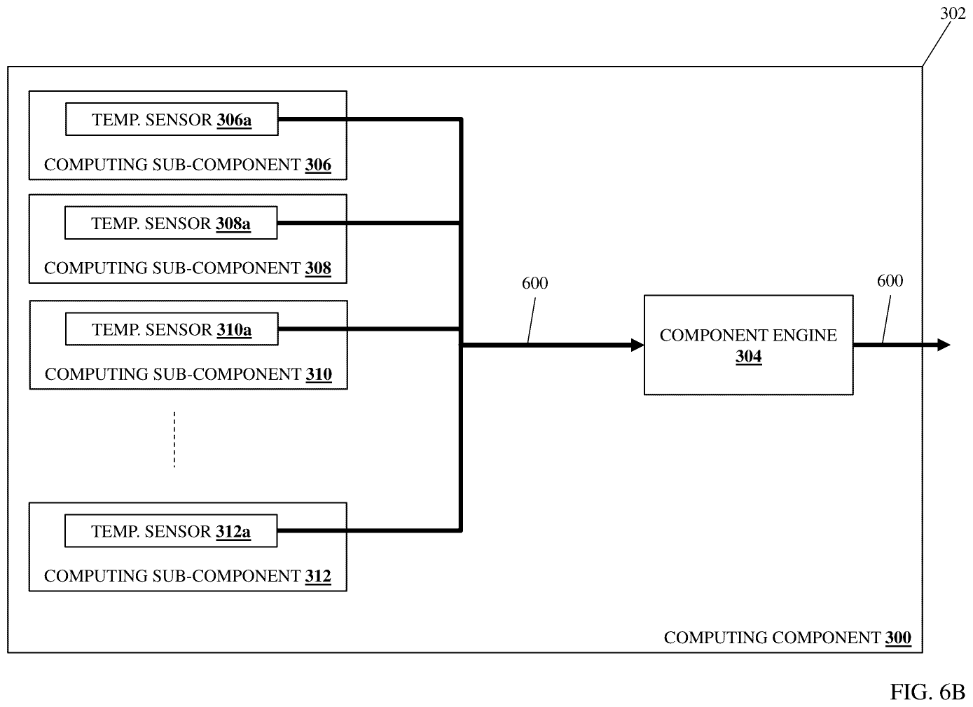

The method 400 then proceeds to block 404 where the BMC device identifies physical temperature sensors in the computing components. With reference to FIGS. 6A and 6B, in an embodiment of block 404, the BMC engine 206 in the BMC device 204 may perform temperature sensor identification operations 600 that may include identifying each of the temperature sensor(s) 208a-214a in the computing components 208-214 (which may include identifying each temperature sensor 306a-312a in the computing component 300 via its computing engine 304 as illustrated in FIG. 6B), and one of skill in the art in possession of the present disclosure will appreciate how the temperature sensor identification operations 600 may be performed as part of the computing component identification operations 500 that are performed at block 402, and/or separately from those computing component identification operations 500. Furthermore, while the identification of temperature sensors 208a-214a and 306a-312a in a plurality of computing components 208-214 and 300, respectively, that are included in the chassis 202 with the BMC device 204 is illustrated and described, one of skill in the art in possession of the present disclosure will appreciate how temperature sensor(s) in external computing components (i.e., computing components outside the chassis 202) that are coupled to the BMC device 204 may be identified at block 404 as well.

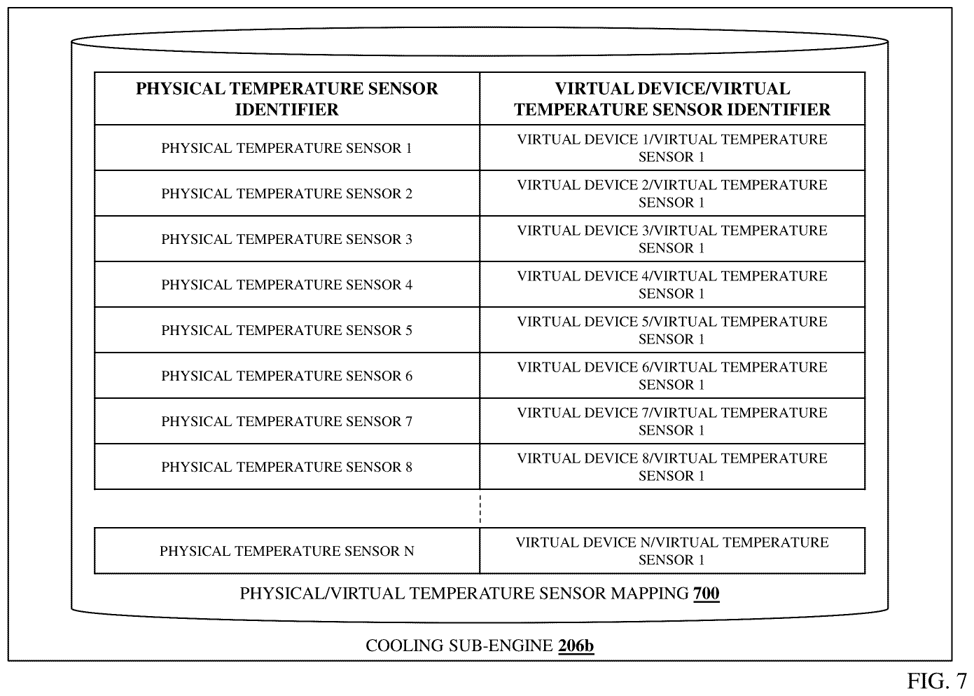

The method 400 then proceeds to block 406 where the BMC device creates at least one virtual device with respective virtual temperature sensors for each physical temperature sensor. With reference to FIG. 7, in an embodiment of block 406, the cooling sub-engine 206b of the BMC engine 206 in the BMC device 204 of the computing device 200 may create virtual device(s) having virtual temperature sensors (e.g., absolute virtual sensors) by generating a physical/virtual temperature sensor mapping 700 that maps each of the physical temperature sensors identified at block 404 with a respective virtual device/virtual temperature sensor. In the specific example provided in FIG. 7, the physical/virtual temperature sensor mapping 700 is provided for computing components that have a single physical temperature sensor, and thus each physical temperature sensor is mapped to a respective virtual temperature sensor included in a respective virtual device.

As such, the physical/virtual temperature sensor mapping 700 includes a first physical temperature sensor (i.e., “PHYSICAL TEMPERATURE SENSOR 1”, which is the single physical temperature sensor in a first computing component in the computing device 200 in this example) mapped to a first virtual temperature sensor in a first virtual device (i.e., “VIRTUAL DEVICE 1/VIRTUAL TEMPERATURE SENSOR 1”), a second physical temperature sensor (i.e., “PHYSICAL TEMPERATURE SENSOR 2”, which is the single physical temperature sensor in a second computing component in the computing device 200 in this example) mapped to a first virtual temperature sensor in a second virtual device (i.e., “VIRTUAL DEVICE 2/VIRTUAL TEMPERATURE SENSOR 1”), a third physical temperature sensor (i.e., “PHYSICAL TEMPERATURE SENSOR 3”, which is the single physical temperature sensor in a third computing component in the computing device 200 in this example) mapped to a first virtual temperature sensor in a third virtual device (i.e., “VIRTUAL DEVICE 3/VIRTUAL TEMPERATURE SENSOR 1”), and up to an Nth physical temperature sensor (i.e., “PHYSICAL TEMPERATURE SENSOR N”, which is the single physical temperature sensor in an Nth computing component in the computing device 200 in this example) mapped to a first virtual temperature sensor in an Nth virtual device (i.e., “VIRTUAL DEVICE N/VIRTUAL TEMPERATURE SENSOR 1”).

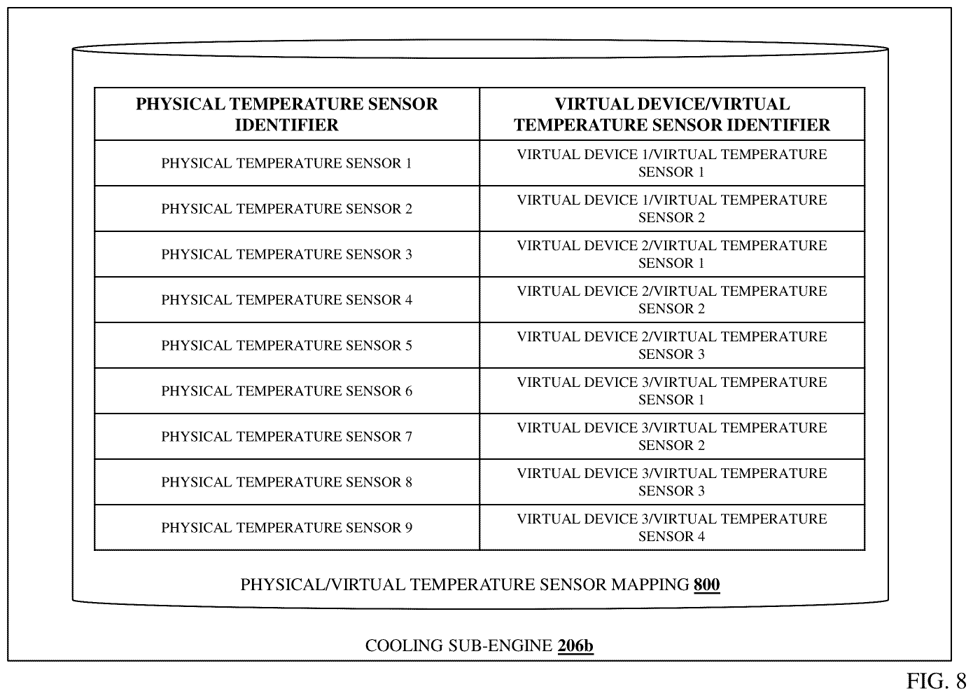

With reference to the specific example provided in FIG. 8, a physical/virtual temperature sensor mapping 800 is provided for computing components that have multiple physical temperature sensors, and thus physical temperature sensors in a computing component are mapped to respective virtual temperature sensors included in a respective virtual device. As will be appreciated by one of skill in the art in possession of the present disclosure, the physical/virtual temperature sensor mapping 800 provides an example in which the number of physical temperature sensors in each computing component does not exceed the temperature sensor limit per computing component for the BMC device 204 (i.e., a 4 temperature sensor limit per computing component in this specific example). As such, the physical/virtual temperature sensor mapping 800 includes a first physical temperature sensor (i.e., “PHYSICAL TEMPERATURE SENSOR 1”, which is a first physical temperature sensor in a first computing component in the computing device 200 in this example) mapped to a first virtual temperature sensor in a first virtual device (i.e., “VIRTUAL DEVICE 1/VIRTUAL TEMPERATURE SENSOR 1”), and a second physical temperature sensor (i.e., “PHYSICAL TEMPERATURE SENSOR 2”, which is a second physical temperature sensor in the first computing component in the computing device 200 in this example) mapped to a second virtual temperature sensor in the first virtual device (i.e., “VIRTUAL DEVICE 1/VIRTUAL TEMPERATURE SENSOR 2”).

Furthermore, the physical/virtual temperature sensor mapping 800 includes a third physical temperature sensor (i.e., “PHYSICAL TEMPERATURE SENSOR 3”, which is a first physical temperature sensor in a second computing component in the computing device 200 in this example) mapped to a first virtual temperature sensor in a second virtual device (i.e., “VIRTUAL DEVICE 2/VIRTUAL TEMPERATURE SENSOR 1”), a fourth physical temperature sensor (i.e., “PHYSICAL TEMPERATURE SENSOR 4”, which is a second physical temperature sensor in the second computing component in the computing device 200 in this example) mapped to a second virtual temperature sensor in the second virtual device (i.e., “VIRTUAL DEVICE 2/VIRTUAL TEMPERATURE SENSOR 2”), and a fifth physical temperature sensor (i.e., “PHYSICAL TEMPERATURE SENSOR 5”, which is a third physical temperature sensor in the second computing component in the computing device 200 in this example) mapped to a third virtual temperature sensor in the second virtual device (i.e., “VIRTUAL DEVICE 2/VIRTUAL TEMPERATURE SENSOR 3”).

Further still, the physical/virtual temperature sensor mapping 800 includes a sixth physical temperature sensor (i.e., “PHYSICAL TEMPERATURE SENSOR 6”, which is a first physical temperature sensor in a third computing component in the computing device 200 in this example) mapped to a first virtual temperature sensor in a third virtual device (i.e., “VIRTUAL DEVICE 3/VIRTUAL TEMPERATURE SENSOR 1”), a seventh physical temperature sensor (i.e., “PHYSICAL TEMPERATURE SENSOR 7”, which is a second physical temperature sensor in the third computing component in the computing device 200 in this example) mapped to a second virtual temperature sensor in the third virtual device (i.e., “VIRTUAL DEVICE 3/VIRTUAL TEMPERATURE SENSOR 2”), an eighth physical temperature sensor (i.e., “PHYSICAL TEMPERATURE SENSOR 8”, which is a third physical temperature sensor in the third computing component in the computing device 200 in this example) mapped to a third virtual temperature sensor in the third virtual device (i.e., “VIRTUAL DEVICE 3/VIRTUAL TEMPERATURE SENSOR 3”), and a ninth physical temperature sensor (i.e., “PHYSICAL TEMPERATURE SENSOR 9”, which is a fourth physical temperature sensor in the third computing component in the computing device 200 in this example) mapped to a fourth virtual temperature sensor in the third virtual device (i.e., “VIRTUAL DEVICE 3/VIRTUAL TEMPERATURE SENSOR 4”).

However, while only three computing components with different numbers of physical temperature sensors (i.e., a first computing component having two physical temperature sensors, a second computing component having three physical temperature sensors, and a third computing component having four physical temperature sensors) are illustrated and described as having those physical temperature sensors mapped to virtual temperature sensors in virtual devices, one of skill in the art in possession of the present disclosure will appreciate how any number of computing components having multiple physical temperature sensors may have those physical temperature sensors mapped to virtual temperature sensors in virtual devices while remaining within the scope of the present disclosure as well.

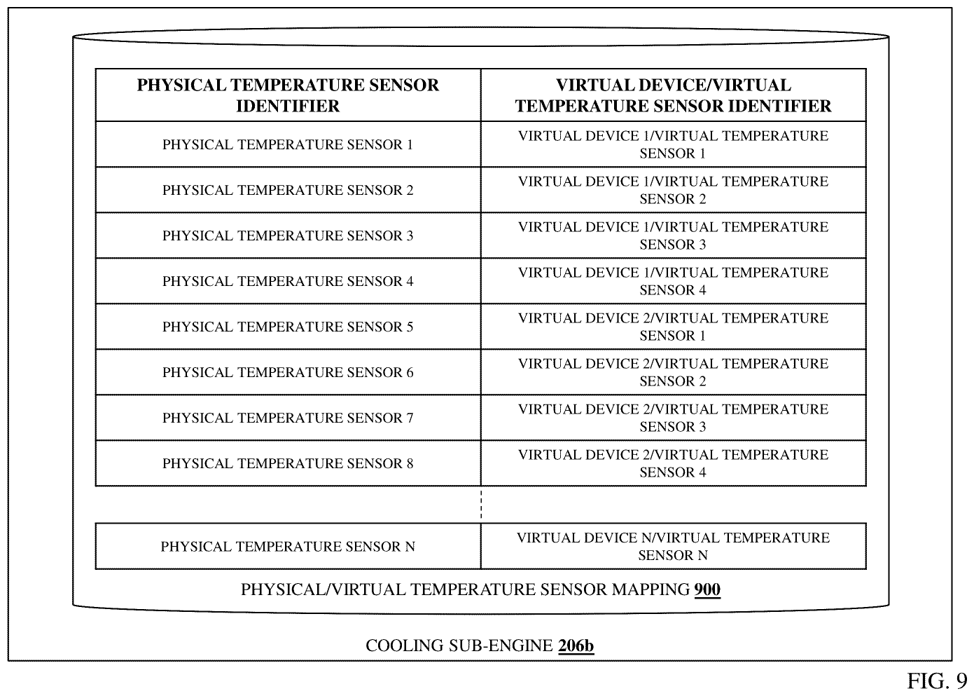

With reference to the specific example provided in FIG. 9, a physical/virtual temperature sensor mapping 900 is provided for a computing component that has a number of physical temperature sensors that exceeds the temperature sensor limit per computing component for the BMC device 204 (i.e., a 4 temperature sensor limit per computing component in this specific example). In such embodiments, for every four physical temperature sensors in the computing component, the cooling sub-engine 206b creates a respective virtual device having four virtual temperature sensors that are mapped to those physical temperature sensors until there are four or less physical temperature sensors left to map, with a final virtual device created having a number of virtual temperature sensors that maps to the number of remaining physical temperature sensors.

As such, the physical/virtual temperature sensor mapping 900 includes a first physical temperature sensor (i.e., “PHYSICAL TEMPERATURE SENSOR 1”, which is a first physical temperature sensor in the computing component in the computing device 200 in this example) mapped to a first virtual temperature sensor in a first virtual device (i.e., “VIRTUAL DEVICE 1/VIRTUAL TEMPERATURE SENSOR 1”), a second physical temperature sensor (i.e., “PHYSICAL TEMPERATURE SENSOR 2”, which is a second physical temperature sensor in the computing component in the computing device 200 in this example) mapped to a second virtual temperature sensor in the first virtual device (i.e., “VIRTUAL DEVICE 1/VIRTUAL TEMPERATURE SENSOR 2”), a third physical temperature sensor (i.e., “PHYSICAL TEMPERATURE SENSOR 3”, which is a third physical temperature sensor in the computing component in the computing device 200 in this example) mapped to a third virtual temperature sensor in the first virtual device (i.e., “VIRTUAL DEVICE 1/VIRTUAL TEMPERATURE SENSOR 3”), and a fourth physical temperature sensor (i.e., “PHYSICAL TEMPERATURE SENSOR 4”, which is a fourth physical temperature sensor in the computing component in the computing device 200 in this example) mapped to a fourth virtual temperature sensor in the first virtual device (i.e., “VIRTUAL DEVICE 1/VIRTUAL TEMPERATURE SENSOR 4”).

Furthermore, the physical/virtual temperature sensor mapping 900 includes a fifth physical temperature sensor (i.e., “PHYSICAL TEMPERATURE SENSOR 5”, which is a fifth physical temperature sensor in the computing component in the computing device 200 in this example) mapped to a first virtual temperature sensor in a second virtual device (i.e., “VIRTUAL DEVICE 2/VIRTUAL TEMPERATURE SENSOR 1”), a sixth physical temperature sensor (i.e., “PHYSICAL TEMPERATURE SENSOR 6”, which is a sixth physical temperature sensor in the computing component in the computing device 200 in this example) mapped to a second virtual temperature sensor in the second virtual device (i.e., “VIRTUAL DEVICE 2/VIRTUAL TEMPERATURE SENSOR 2”), a seventh physical temperature sensor (i.e., “PHYSICAL TEMPERATURE SENSOR 7”, which is a seventh physical temperature sensor in the computing component in the computing device 200 in this example) mapped to a third virtual temperature sensor in the second virtual device (i.e., “VIRTUAL DEVICE 2/VIRTUAL TEMPERATURE SENSOR 3”), and a eighth physical temperature sensor (i.e., “PHYSICAL TEMPERATURE SENSOR 8”, which is an eighth physical temperature sensor in the computing component in the computing device 200 in this example) mapped to a fourth virtual temperature sensor in the second virtual device (i.e., “VIRTUAL DEVICE 2/VIRTUAL TEMPERATURE SENSOR 4”).

As will be appreciated by one of skill in the art in possession of the present disclosure, for each set of remaining four physical temperature sensors that have not been mapped to a virtual temperature sensor, a respective virtual device may be created and may have its four virtual temperature sensors mapped to those physical temperature sensors (i.e., PHYSICAL TEMPERATURE SENSOR 9, 10, 11, and 12 may be mapped to VIRTUAL DEVICE 3/VIRTUAL TEMPERATURE SENSOR 1, 2, 3, and 4, respectively; PHYSICAL TEMPERATURE SENSOR 13, 14, 15, and 16 may be mapped to VIRTUAL DEVICE 4/VIRTUAL TEMPERATURE SENSOR 1, 2, 3, and 4; and so on). Furthermore, if there are less than four physical temperature sensors left to map in the computing component, a virtual device may be created with a number of virtual temperature sensors that each map to a respective one of those remaining physical temperature sensors. As such, a multi-GPU component like those discussed above having 50 temperature sensors may have each of its physical temperature sensors mapped a respective one of four virtual temperature sensors included in 12 virtual devices, or respective one of two virtual temperature sensors in a 13^{th} virtual device.

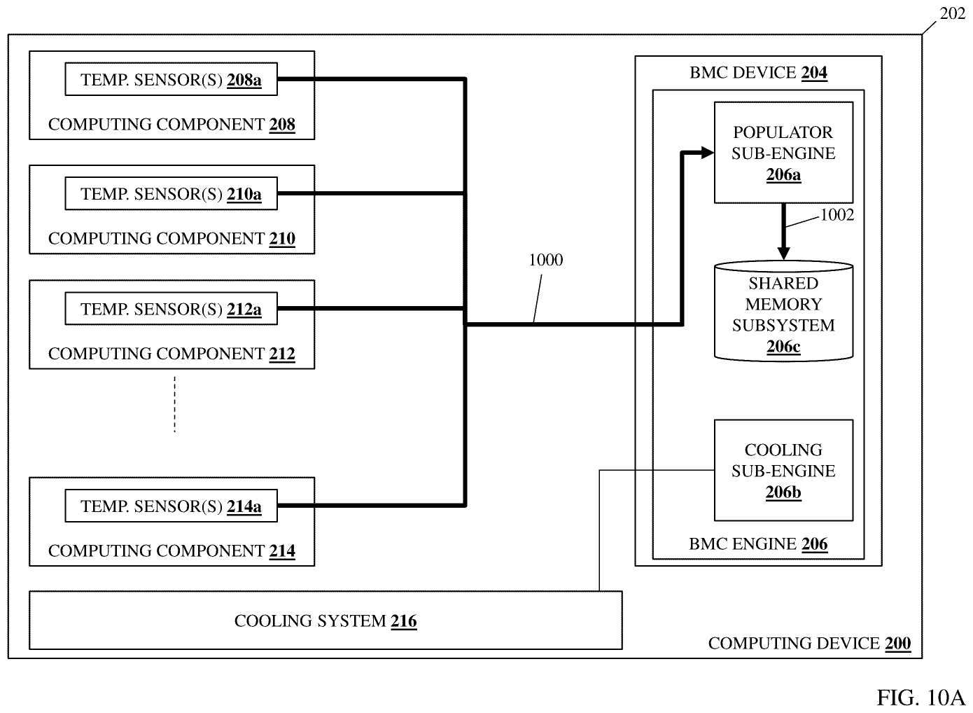

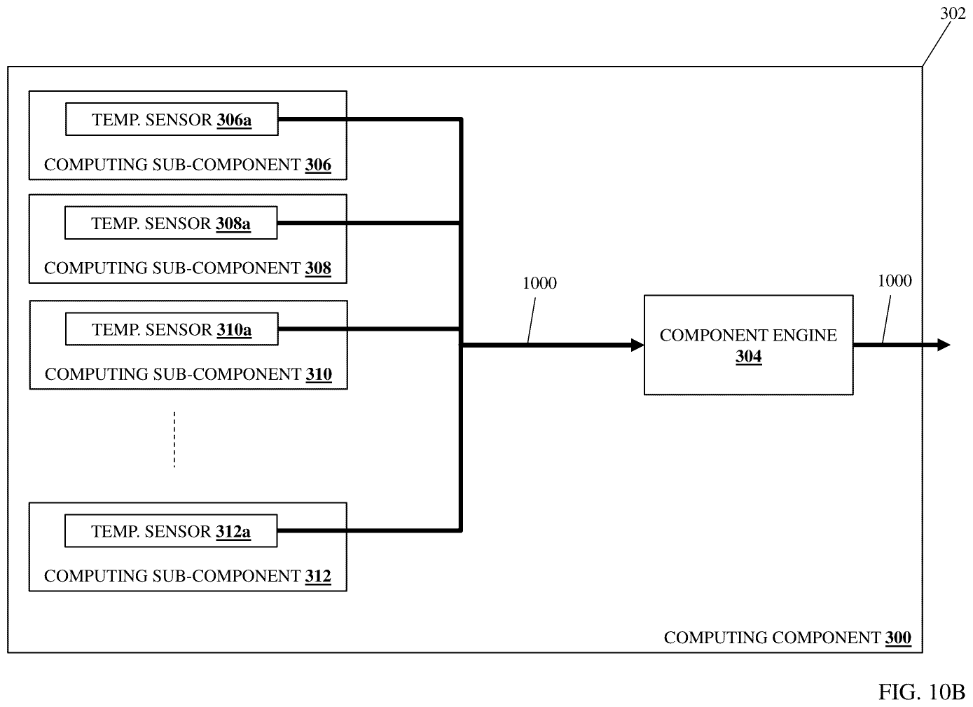

The method 400 then proceeds to block 408 where the BMC device retrieves temperature data from each physical temperature sensor. With reference to FIGS. 10A and 10B, in an embodiment of block 408, the BMC engine 206 in the BMC device 204 may perform temperature data retrieval operations 1000 that may include retrieving, from each of the temperature sensor(s) 208a-214a in the computing components 208-214 (which may include each temperature sensor 306a-312a in the computing component 300 via its computing engine 304 as illustrated in FIG. 10B), respective temperature data generated by that temperature sensor (e.g., using respective “GetSensorReading” PLDM commands). Furthermore, while the retrieval of temperature data from temperature sensors 208a-214a and 306a-312a in a plurality of computing components 208-214 and 300, respectively, that are included in the chassis 202 with the BMC device 204 is illustrated and described, one of skill in the art in possession of the present disclosure will appreciate how temperature data may be retrieved from temperature sensors in external computing components (i.e., computing components outside the chassis 202) that are coupled to the BMC device 204 as well.

As illustrated in FIG. 10A, in response to retrieving temperature data via the temperature data retrieval operations 1000, the populator sub-engine 206a in the BMC engine 206 of the BMC device 204 may perform temperature data storage operations 1002 that include storing that temperature data in the shared memory subsystem 206c. For example, with reference back to FIG. 7, one of skill in the art in possession of the present disclosure will appreciate how the temperature data storage operations 1002 may include storing respective temperature data retrieved for each physical temperature sensor according to the physical/virtual temperature sensor mapping 700 so that temperature data retrieved for a physical temperature sensor is stored in association with its mapped virtual device/virtual temperature sensor. As such, temperature data retrieved from the PHYSICAL TEMPERATURE SENSOR 1 of a first computing component may be stored in the shared memory subsystem 206c in association with the VIRTUAL DEVICE 1/VIRTUAL TEMPERATURE SENSOR 1 mapped thereto, temperature data retrieved from the PHYSICAL TEMPERATURE SENSOR 2 of a second computing component may be stored in the shared memory subsystem 206c in association with the VIRTUAL DEVICE 2/VIRTUAL TEMPERATURE SENSOR 1 mapped thereto, and so on up to the storage of temperature data retrieved from the PHYSICAL TEMPERATURE SENSOR N in an Nth computing component in the shared memory subsystem 206c in association with the VIRTUAL DEVICE N/VIRTUAL TEMPERATURE SENSOR 1 mapped thereto.

Similarly, with reference back to FIG. 8, one of skill in the art in possession of the present disclosure will appreciate how the temperature data storage operations 1002 may include storing respective temperature data retrieved for each physical temperature sensor according to the physical/virtual temperature sensor mapping 800 so that temperature data retrieved for a physical temperature sensor is stored in association with its mapped virtual device/virtual temperature sensor. As such, temperature data retrieved from the PHYSICAL TEMPERATURE SENSOR 1 of a first computing component may be stored in the shared memory subsystem 206c in association with the VIRTUAL DEVICE 1/VIRTUAL TEMPERATURE SENSOR 1 mapped thereto, temperature data retrieved from the PHYSICAL TEMPERATURE SENSOR 2 of the first computing component may be stored in the shared memory subsystem 206c in association with the VIRTUAL DEVICE 1/VIRTUAL TEMPERATURE SENSOR 2 mapped thereto, temperature data retrieved from the PHYSICAL TEMPERATURE SENSOR 3 of a second computing component may be stored in the shared memory subsystem 206c in association with the VIRTUAL DEVICE 2/VIRTUAL TEMPERATURE SENSOR 1 mapped thereto, and so on such that the physical temperature sensors in each computing component are mapped to the virtual temperature sensors in each respective virtual device mapped thereto.

Similarly, with reference back to FIG. 9, one of skill in the art in possession of the present disclosure will appreciate how the temperature data storage operations 1002 may include storing respective temperature data retrieved for each physical temperature sensor according to the physical/virtual temperature sensor mapping 900 so that temperature data retrieved for a physical temperature sensor is stored in association with its mapped virtual device/virtual temperature sensor. As such, temperature data retrieved from the PHYSICAL TEMPERATURE SENSOR 1 of a computing component may be stored in the shared memory subsystem 206c in association with the VIRTUAL DEVICE 1/VIRTUAL TEMPERATURE SENSOR 1 mapped thereto, temperature data retrieved from the PHYSICAL TEMPERATURE SENSOR 2 of the computing component may be stored in the shared memory subsystem 206c in association with the VIRTUAL DEVICE 1/VIRTUAL TEMPERATURE SENSOR 2 mapped thereto, temperature data retrieved from the PHYSICAL TEMPERATURE SENSOR 3 of the computing component may be stored in the shared memory subsystem 206c in association with the VIRTUAL DEVICE 1/VIRTUAL TEMPERATURE SENSOR 3 mapped thereto, and temperature data retrieved from the PHYSICAL TEMPERATURE SENSOR 4 of the computing component may be stored in the shared memory subsystem 206c in association with the VIRTUAL DEVICE 1/VIRTUAL TEMPERATURE SENSOR 4 mapped thereto.

Continuing with this example, temperature data retrieved from the PHYSICAL TEMPERATURE SENSOR 5 of the computing component may be stored in the shared memory subsystem 206c in association with the VIRTUAL DEVICE 2/VIRTUAL TEMPERATURE SENSOR 1 mapped thereto, temperature data retrieved from the PHYSICAL TEMPERATURE SENSOR 6 of the computing component may be stored in the shared memory subsystem 206c in association with the VIRTUAL DEVICE 2/VIRTUAL TEMPERATURE SENSOR 2 mapped thereto, and so on such that respective temperature data retrieved each set of four physical temperature sensors in the computing component is stored in the shared memory subsystem 206c in association with the four corresponding virtual temperature sensors in respective virtual devices mapped thereto, and if there are less than four physical temperature sensors from the computing component that are mapped to corresponding virtual temperature sensors in a virtual device, the respective temperature data retrieved from those physical temperature sensors is stored in the shared memory subsystem 206c in association with those virtual temperature sensors as well.

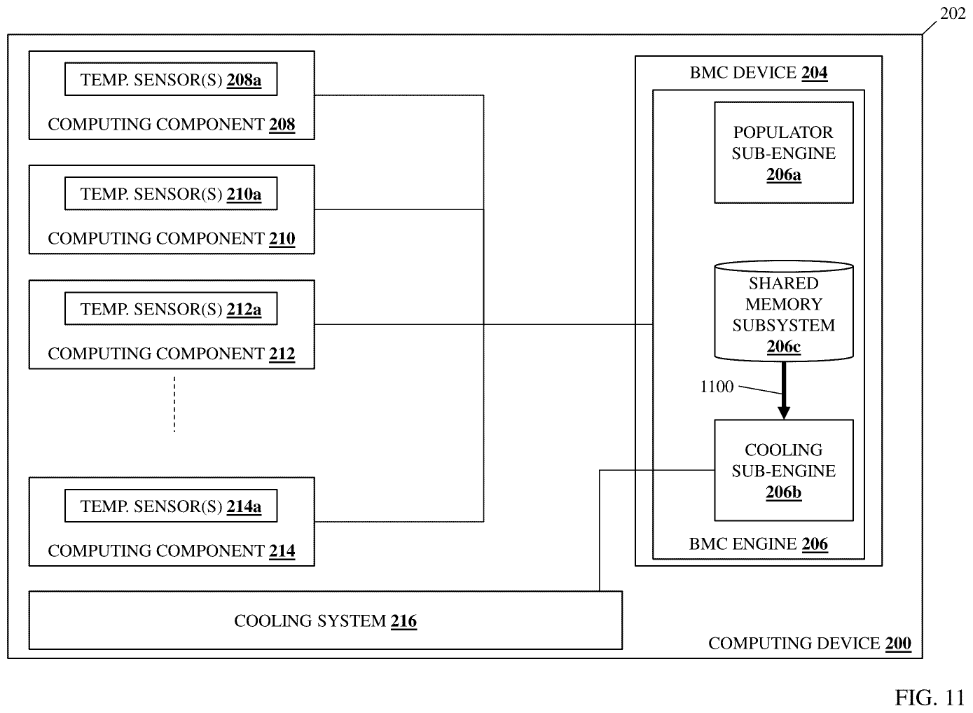

The method 400 then proceeds to block 410 where the BMC device provides, for each virtual temperature sensor included in the virtual device(s), respective temperature data retrieved from the physical temperature sensor for which that virtual temperature sensor was created in a cooling control algorithm to generate cooling system control information. With reference to FIG. 11, in an embodiment of block 410, the cooling sub-engine 206b (e.g., the thermal daemon described above) may perform cooling control algorithm temperature data provisioning operations 1100 that may include retrieving temperature data from the shared memory subsystem 206c and providing that temperature data in the cooling control algorithm that may be included in the cooling sub-engine 206b as described above in order to generate cooling system control information. As will be appreciated by one of skill in the art in possession of the present disclosure, cooling control algorithm temperature data provisioning operations 1100 may include the cooling sub-engine 206b periodic (e.g., every 1 second) polling of the temperature data in the shared memory subsystem 206c and provisioning of that temperature data in the cooling control algorithm.

For example, with reference back to FIG. 7, one of skill in the art in possession of the present disclosure will appreciate how the cooling control algorithm temperature data provisioning operations 1100 may include retrieving temperature data stored in association with the virtual devices/virtual temperature sensors identified in the physical/virtual temperature sensor mapping 700 and providing that temperature data in corresponding portions of the cooling control algorithm that require temperature data from those virtual temperature sensors in order to generate the cooling system control information.

As such, temperature data associated with the VIRTUAL DEVICE 1/VIRTUAL TEMPERATURE SENSOR 1 may be retrieved from the shared memory subsystem 206c and provided in a portion of the cooling control algorithm that requires temperature data from VIRTUAL TEMPERATURE SENSOR 1 in VIRTUAL DEVICE 1 in order to generate the cooling system control information, temperature data associated with the VIRTUAL DEVICE 2/VIRTUAL TEMPERATURE SENSOR 1 may be retrieved from the shared memory subsystem 206c and provided in a portion of the cooling control algorithm that requires temperature data from VIRTUAL TEMPERATURE SENSOR 1 in VIRTUAL DEVICE 2 in order to generate the cooling system control information, and so on up to the retrieval of temperature data associated with the VIRTUAL DEVICE N/VIRTUAL TEMPERATURE SENSOR 1 from the shared memory subsystem 206c and the provisioning of that data in a portion of the cooling control algorithm that requires temperature data from VIRTUAL TEMPERATURE SENSOR 1 in VIRTUAL DEVICE N in order to generate the cooling system control information.

Similarly, with reference back to FIG. 8, one of skill in the art in possession of the present disclosure will appreciate how the cooling control algorithm temperature data provisioning operations 1100 may include retrieving temperature data stored in association with the virtual devices/virtual temperature sensors identified in the physical/virtual temperature sensor mapping 800 and providing that temperature data in corresponding portions of the cooling control algorithm that require temperature data from those virtual temperature sensors in order to generate the cooling system control information. As such, temperature data associated with the VIRTUAL DEVICE 1/VIRTUAL TEMPERATURE SENSOR 1 may be retrieved from the shared memory subsystem 206c and provided in a portion of the cooling control algorithm that requires temperature data from VIRTUAL TEMPERATURE SENSOR 1 in VIRTUAL DEVICE 1 in order to generate the cooling system control information, temperature data associated with the VIRTUAL DEVICE 1/VIRTUAL TEMPERATURE SENSOR 2 may be retrieved from the shared memory subsystem 206c and provided in a portion of the cooling control algorithm that requires temperature data from VIRTUAL TEMPERATURE SENSOR 2 in VIRTUAL DEVICE 1 in order to generate the cooling system control information, and so on such that temperature data associated with each virtual temperature sensor in each virtual device is retrieved and provided in its corresponding portion of the cooling control algorithm in order to generate the cooling system control information.

Similarly, with reference back to FIG. 9, one of skill in the art in possession of the present disclosure will appreciate how the cooling control algorithm temperature data provisioning operations 1100 may include retrieving temperature data stored in association with the virtual devices/virtual temperature sensors identified in the physical/virtual temperature sensor mapping 900 and providing that temperature data in corresponding portions of the cooling control algorithm that require temperature data from those virtual temperature sensors in order to generate the cooling system control information. As such, temperature data associated with the VIRTUAL DEVICE 1/VIRTUAL TEMPERATURE SENSOR 1 may be retrieved from the shared memory subsystem 206c and provided in a portion of the cooling control algorithm that requires temperature data from VIRTUAL TEMPERATURE SENSOR 1 in VIRTUAL DEVICE 1 in order to generate the cooling system control information, temperature data associated with the VIRTUAL DEVICE 1/VIRTUAL TEMPERATURE SENSOR 2 may be retrieved from the shared memory subsystem 206c and provided in a portion of the cooling control algorithm that requires temperature data from VIRTUAL TEMPERATURE SENSOR 2 in VIRTUAL DEVICE 1 in order to generate the cooling system control information, and so on such that temperature data associated with each virtual temperature sensor in each virtual device is retrieved and provided in its corresponding portion of the cooling control algorithm in order to generate the cooling system control information.

In an embodiment, the cooling control algorithm may provide for the calculation of PWM values for any temperature data provided therein (e.g., with the highest PWM value selected in order to generate the cooling system control information in some specific examples), and as discussed above the calculation of PWM values is relatively processing intensive. As will be appreciated by one of skill in the art in possession of the present disclosure, the multiple-virtual-temperature-sensor-per-computing-component cooling system of the present disclosure may operate to circumvent a configuration of the BMC engine 206 in the BMC device 206 that operates to conserve its processing resources by only calculating PWM values for some maximum number of temperature sensors per computing component (e.g., a maximum of 4 temperature sensors per PLDM device in the specific examples provided above). As such, in computing devices with a relatively high number of temperature sensors (e.g., a computing device that includes the multi-GPU component with 50 or more temperature sensors as described above), the cooling sub-engine 206b in the BMC engine 206 of the BMC device 204 may be configured to only provide temperature data from subsets of virtual temperature sensors/physical temperature sensors in the cooling control algorithm.

For example, during a first time period, the cooling sub-engine 206b may be configured to retrieve first respective temperature data from the shared memory subsystem 206c that was retrieved from a first subset of the physical temperature sensors in the computing device 200 and stored in association with a first subset of virtual temperature sensors mapped thereto, and then provide that temperature data in corresponding portions of the cooling control algorithm that require temperature data from those virtual temperature sensors for use in calculating corresponding PWM values as described above in order to generate the cooling system control information during the first time period.

Subsequently, during a second time period, the cooling sub-engine 206b may be configured to retrieve second respective temperature data from the shared memory subsystem 206c that was retrieved from a second subset of the physical temperature sensors in the computing device 200 (that are different than the first subset of physical temperature sensors discussed above) and stored in association with a second subset of virtual temperature sensors (that are different than the first subset of virtual temperature sensors discussed above) mapped thereto, and provide that temperature data in corresponding portions of the cooling control algorithm that require temperature data from those virtual temperature sensors for use in calculating corresponding PWM values as described above in order to generate the cooling system control information during the second time period. Furthermore, one of skill in the art in possession of the present disclosure will appreciate how other, different subsets of temperature data may be retrieved from the shared memory subsystem 206c and provided in the cooling control algorithm for use in calculating corresponding PWM values during other, different time periods in order to reduce the processing burden on the BMC engine 206 to a desired level when generating the cooling system control information during any particular time period.

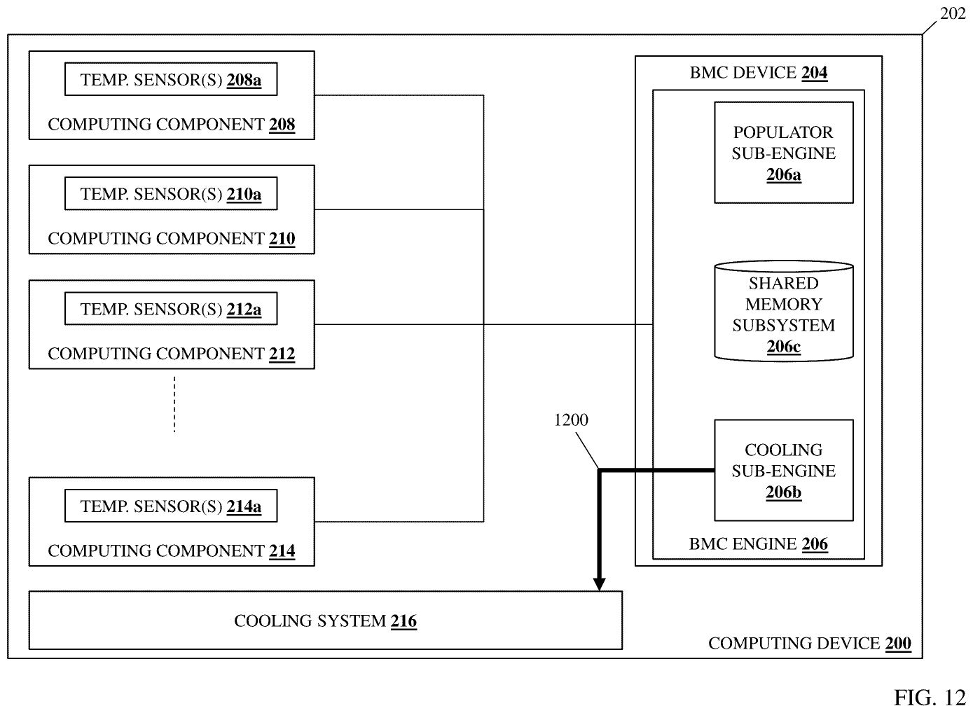

The method 400 then proceeds to block 412 where the BMC device uses the cooling system control information to control a cooling system. With reference to FIG. 12, in an embodiment of block 412, the cooling sub-engine 206b in the BMC engine 206 of the BMC device 204 may then perform cooling system control operations 1200 that include using the cooling system control information to control the cooling system 216 in order to, for example, generate an airflow past the computing components 208-214 (and in some cases the computing sub-components 306-312 in the computing component 300).

Thus, systems and methods have been described that create one or more virtual devices having a plurality of virtual temperature sensors that each correspond to one of a plurality of physical temperature sensors in a computing component, and then provide, for each virtual temperature sensor in the virtual device(s), temperature data retrieved from its corresponding physical temperature sensor in a cooling control algorithm for use in controlling a cooling system. For example, the multiple-virtual-temperature-sensor-per-computing-component cooling system may include a chassis housing a cooling system and a BMC device coupled to a computing component that includes physical temperature sensors. The BMC device identifies the physical temperature sensors included in the computing component, and creates virtual device(s) that includes a respective virtual temperature sensor for each of the physical temperature sensors. The BMC device then retrieves respective temperature data from each of the physical temperature sensors and, for each virtual temperature sensor included in the virtual device(s), provides the respective temperature data that was retrieved from the physical temperature sensor for which that virtual temperature sensor was created in a cooling system control algorithm to generate cooling system control information. The BMC device then uses the cooling system control information to control the cooling system. As such, “generic” closed-loop cooling control is provided through a consolidated management path and protocol for complex computing components with relatively high numbers of temperature sensors, while maintaining backwards compatibility such that a temperature sensor limit per computing component for the BMC device will not prevent the monitoring of temperature sensors in those complex computing components.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A multiple-virtual-temperature-sensor-per-computing-component cooling system, comprising:
a chassis;
a cooling system that is housed in the chassis;
a computing component that is housed in the chassis and that includes a plurality of physical temperature sensors; and
a Baseboard Management Controller (BMC) device that is housed in the chassis and coupled to the computing component, wherein the BMC device is configured to:
identify the plurality of physical temperature sensors included in the computing component;
create at least one virtual device that includes a respective virtual temperature sensor for each of the plurality of physical temperature sensors;
retrieve respective temperature data from each of the plurality of physical temperature sensors;
provide, for each virtual temperature sensor included in the at least one virtual device, the respective temperature data that was retrieved from the physical temperature sensor for which that virtual temperature sensor was created in a cooling system control algorithm to generate cooling system control information; and
use the cooling system control information to control the cooling system.

2. The system of claim 1, wherein the respective temperature data is retrieved from each of the plurality of physical temperature sensors according to the Platform Level Data Model (PLDM).

3. The system of claim 1, wherein the at least one virtual device includes a single virtual device including the respective virtual temperature sensor for each of the plurality of physical temperature sensors in the computing component.

4. The system of claim 1, wherein the at least one virtual device includes a first virtual device including the respective virtual temperature sensors for each of a first subset of the plurality of physical temperature sensors in the computing component, and a second virtual device including the respective virtual temperature sensors for each of a second subset of the plurality of physical temperature sensors in the computing component.

5. The system of claim 4, wherein the first subset of the plurality of physical temperature sensors in the computing component consists of four physical temperature sensors, and the second subset of the plurality of physical temperature sensors in the computing component includes a maximum of four physical temperature sensors.

6. The system of claim 4, wherein the BMC device is configured to:
provide first respective temperature data retrieved from each of the physical temperature sensors included in the first subset of the plurality of physical temperature sensors in the computing component in the cooling system control algorithm to generate first cooling system control information during a first time period; and
provide second respective temperature data retrieved from each of the physical temperature sensors included in the second subset of the plurality of physical temperature sensors in the computing component in the cooling system control algorithm to generate second cooling system control information during a second time period that is different than the first time period.

7. The system of claim 1, wherein the computing component includes:
a plurality of Graphics Processing Units (GPUs), wherein at least one of the plurality of physical temperature sensors is provided for each of the plurality of GPUs.

8. An Information Handling System (IHS), comprising:
a Baseboard Management Controller (BMC) processing system; and
a BMC memory system that is coupled to the BMC processing system and that includes instructions that, when executed by the BMC processing system, cause the BMC processing system to provide a BMC engine that is configured to:
identify a plurality of physical temperature sensors included in a computing component that is coupled to the BMC processing system;
create at least one virtual device that includes a respective virtual temperature sensor for each of the plurality of physical temperature sensors;
retrieve respective temperature data from each of the plurality of physical temperature sensors;
provide, for each virtual temperature sensor included in the at least one virtual device, the respective temperature data that was retrieved from the physical temperature sensor for which that virtual temperature sensor was created in a cooling system control algorithm to generate cooling system control information; and
use the cooling system control information to control a cooling system.

9. The IHS of claim 8, wherein the respective temperature data is retrieved from each of the plurality of physical temperature sensors according to the Platform Level Data Model (PLDM).

10. The IHS of claim 8, wherein the at least one virtual device includes a single virtual device including the respective virtual temperature sensor for each of the plurality of physical temperature sensors in the computing component.

11. The IHS of claim 8, wherein the at least one virtual device includes a first virtual device including the respective virtual temperature sensors for each of a first subset of the plurality of physical temperature sensors in the computing component, and a second virtual device including the respective virtual temperature sensors for each of a second subset of the plurality of physical temperature sensors in the computing component.

12. The IHS of claim 11, wherein the first subset of the plurality of physical temperature sensors in the computing component consists of four physical temperature sensors, and the second subset of the plurality of physical temperature sensors in the computing component includes a maximum of four physical temperature sensors.

13. The IHS of claim 11, wherein the BMC engine is configured to:
provide first respective temperature data retrieved from each of the physical temperature sensors included in the first subset of the plurality of physical temperature sensors in the computing component in the cooling system control algorithm to generate first cooling system control information during a first time period; and
provide second respective temperature data retrieved from each of the physical temperature sensors included in the second subset of the plurality of physical temperature sensors in the computing component in the cooling system control algorithm to generate second cooling system control information during a second time period that is different than the first time period.

14. A method for controlling a cooling system using multiple virtual temperature sensors per computing component, comprising:
identifying, by a Baseboard Management Controller (BMC) device, a plurality of physical temperature sensors included in a computing component;
creating, by the BMC device, at least one virtual device that includes a respective virtual temperature sensor for each of the plurality of physical temperature sensors;
retrieving, by the BMC device, respective temperature data from each of the plurality of physical temperature sensors;
providing, by the BMC device for each virtual temperature sensor included in the at least one virtual device, the respective temperature data that was retrieved from the physical temperature sensor for which that virtual temperature sensor was created in a cooling system control algorithm to generate cooling system control information; and
using, by the BMC device, the cooling system control information to control a cooling system.

15. The method of claim 14, wherein the respective temperature data is retrieved from each of the plurality of physical temperature sensors according to the Platform Level Data Model (PLDM).

16. The method of claim 14, wherein the at least one virtual device includes a single virtual device including the respective virtual temperature sensor for each of the plurality of physical temperature sensors in the computing component.

17. The method of claim 14, wherein the at least one virtual device includes a first virtual device including the respective virtual temperature sensors for each of a first subset of the plurality of physical temperature sensors in the computing component, and a second virtual device including the respective virtual temperature sensors for each of a second subset of the plurality of physical temperature sensors in the computing component.

18. The method of claim 17, wherein the first subset of the plurality of physical temperature sensors in the computing component consists of four physical temperature sensors, and the second subset of the plurality of physical temperature sensors in the computing component includes a maximum of four physical temperature sensors.

19. The method of claim 14, further comprising:
providing, by the BMC device, first respective temperature data retrieved from each of the physical temperature sensors included in the first subset of the plurality of physical temperature sensors in the computing component in the cooling system control algorithm to generate first cooling system control information during a first time period; and
providing, by the BMC device, second respective temperature data retrieved from each of the physical temperature sensors included in the second subset of the plurality of physical temperature sensors in the computing component in the cooling system control algorithm to generate second cooling system control information during a second time period that is different than the first time period.

20. The method of claim 14, wherein the computing component includes:
a plurality of Graphics Processing Units (GPUs), wherein at least one of the plurality of physical temperature sensors is provided for each of the plurality of GPUs.
